(19) United States
(12) Patent Application Publication
(10) Pub. No.: US 2026/0364778 A1
(43) Pub. Date: Nov. 19, 2026

(54) ROBOT JOINT MODULE AND METHOD FOR USE

(71) Applicant: JILIN UNIVERSITY, Changchun (CN)

(72) Inventors: Konghua YANG, Changchun (CN); Chunbao LIU, Changchun (CN); Changyi ZHAO, Changchun (CN); Yibin LIU, Changchun (CN); Lu ZHAI, Changchun (CN)

(21) Appl. No.: 19/411,023

(22) Filed: Dec. 5, 2025

(30) Foreign Application Priority Data
May 14, 2025 (CN) 202510617806.3

(51) Int. Cl. B25J 9/00; B25J 9/10; B25J 13/08; B25J 17/00

(52) U.S. Cl. CPC B25J 9/0009; B25J 9/102; B25J 13/08; B25J 17/00

(57) ABSTRACT

A robot joint module and a method for use is disclosed. The robot joint module includes a module housing, with a servo motor disposed inside the module housing. An intelligent encoder is disposed on the servo motor. A separation assembly is disposed inside the module housing and includes multiple separation grooves formed on an inner side surface of the module housing. A separation ring is slidably disposed inside the module housing, and stabilizing rings are firmly connected inside the separation grooves respectively. A meshing transmission relationship between the speed reduction gear set and the servo motor is disconnected, to prevent the impact of the device on internal gear meshing after overload. The second cylindrical spur gear is separated from the first cylindrical spur gear during overload, to prevent continued operation after overload.

### CROSS-REFERENCE TO RELATED APPLICATIONS

The present application claims priority to Chinese patent application No. 202510617806.3, titled “ROBOT JOINT MODULE AND METHOD FOR USE”, filed on May 14, 2025, the entire contents of which are incorporated herein by reference.

### FIELD OF TECHNOLOGY

The present invention relates to the field of robotics technology, and in particular to a robot joint module and a method for use.

### BACKGROUND

Conventional robot joint modules typically adopt an integrated design, with a core power unit including a servo motor, a speed reduction mechanism, sensors, and transmission components. The servo motor is directly connected to the speed reduction mechanism via an output shaft, forming a high-torque and high-precision power transmission chain. To enhance structural compactness, existing joint modules often adopt an integrated design, encapsulating a motor, a speed reducer, and an intelligent encoder within a single housing, while relying on rigid connections or preloading mechanisms to ensure the stability of gear ring meshing. Such design can meet high-precision motion requirements of robot joints under a light load or static conditions.

However, when the robot is handling cargo, the cargo imposes a load on the robot joint module. In a robot arm-hanging joint module, a speed reduction gear set and a servo motor are rigidly meshed, namely, connected via gears. Therefore, when the robot joint is subjected to an external load, a load torque is transmitted through the speed reduction mechanism to the internal gear set, causing meshing surfaces of the speed reduction mechanism and the internal gear set to bear additional asymmetric stresses, resulting in uneven contact pressure distribution on the meshing surfaces and increased local friction. In addition, if the robot joint module continues to operate under a load exceeding a rated capacity, further wear on internal gears may occur, which can easily lead to meshing surface deformation or increased clearance, decreased gear ring meshing tightness, and backlash or vibration during transmission, directly affecting positioning accuracy of joint movement, and even damaging the joint module.

### SUMMARY

To solve the above technical problems, the present invention provides a robot joint module and a method for use.

Technical solutions are as follows:
The present invention provides a robot joint module, including a module housing, where a servo motor is disposed inside the module housing, and a separation assembly is disposed inside the module housing;
the separation assembly includes a separation groove formed on an inner side surface of the module housing, a separation ring is slidably disposed inside the module housing and is slidably connected to the separation groove, a stabilizing ring is firmly connected inside the separation groove, a connecting rod is firmly connected to a side surface of the separation ring, passes through the stabilizing ring, and is firmly connected to an iron plate, a first spring is firmly connected between a surface of the iron plate near the connecting rod and a groove wall of the separation groove, a first electromagnet is firmly connected to a groove wall of a side of the separation groove away from the servo motor, a first cylindrical spur gear is firmly connected to an output shaft of the servo motor, a speed reduction gear set is disposed inside the separation ring, an input shaft is disposed on a side of the speed reduction gear set near the servo motor, an output shaft is disposed on a side of the speed reduction gear set away from the servo motor, a second cylindrical spur gear is firmly connected to the input shaft of the speed reduction gear set, and the first cylindrical spur gear meshes with the second cylindrical spur gear; and further including a detection assembly for detecting a load borne by the output shaft of the speed reduction gear set and a support assembly for limiting the output shaft.

Further, an outer ring surface of the separation ring is provided with a protrusion, the protrusion of the separation ring is slidably connected inside the separation groove, and the connecting rod slides inside the stabilizing ring.

Further, the detection assembly includes two end plates respectively fastened to both ends of the module housing by bolts, a mounting hole for the output shaft of the speed reduction gear set is provided in an end plate on a side away from the servo motor, the servo motor is firmly connected to an adjacent end plate by a bolt, a bearing is mounted in the mounting hole in the end plate, an outer ring of the bearing is fastened to the mounting hole in the end plate, multiple pressure sensors arranged in an annular array are fastened between the outer ring of the bearing and an inner side wall of the mounting hole in the end plate, a slider is fastened to an inner side wall of an inner ring of the bearing, a sliding groove corresponding to the slider is formed on the output shaft of the speed reduction gear set, and the slider on the bearing slides within the sliding groove.

Further, the support assembly includes a fastened ring firmly connected to an inner side wall of the module housing, two inner ring frames disposed opposite to each other are firmly connected to an inner side wall of the fastened ring, circular groove rings are provided on the inner ring frames, multiple sets of telescopic rods are rotatably connected to the inner side wall of the fastened ring, each set includes two telescopic rods, each telescopic rod includes a fastened end and a telescopic end, a second spring is disposed between the fastened end and the telescopic end, the fastened end is rotatably connected to the fastened ring, telescopic ends of the two telescopic rods in the same set are jointly and rotatably connected to a connecting shaft, both ends of the connecting shaft are slidably connected to the circular groove rings of the two inner ring frames respectively, each connecting shaft is firmly connected to a support housing, multiple support housings are jointly and firmly connected to an inner ring, multiple openings are formed in the inner ring, with a quantity of the openings corresponding to a quantity of the support housings, the openings of the inner ring are in communication with an interior of the adjacent support housing, the inner ring is sleeved outside the output shaft of the speed reduction gear set, two third springs are symmetrically fastened inside each support housing, ends of the two third springs away from a connection to the support housing are jointly and firmly connected to a clamping block, a second electromagnet is disposed inside the clamping block, a magnet is firmly connected inside the support housing, and intelligent encoders are provided on the servo motor and the separation ring respectively.

Further, after the second electromagnet on the clamping block is energized, magnetic poles on sides of the second electromagnet and the magnet that are close to each other are the same.

Further, the support assembly further includes two limit rings firmly connected to the output shaft of the speed reduction gear set, multiple support grooves are formed on an outer surface of the output shaft of the speed reduction gear set and located between the two limit rings, and a quantity of the support grooves corresponds to a quantity of the clamping blocks.

The present invention further provides a method for using a robot joint module, which is used in the robot joint module as described above. The method includes the following steps:
step 1: when the pressure sensor detects that a load on the output shaft of the speed reduction gear set exceeds a rated load, the first electromagnet is energized and attracts the iron plate, and the iron plate drives the connecting rod and the separation ring to move along the separation groove, causing the second cylindrical spur gear to be separated from the first cylindrical spur gear;
step 2: when the first electromagnet is energized, the second electromagnet on the clamping block is energized and repels the magnet, pushing the clamping block into the support groove to connect the output shaft of the speed reduction gear set to the support housing, and the output shaft of the speed reduction gear set is buffered and supported through the telescopic rod and the second spring; and
step 3: when the pressure sensor detects that the load on the output shaft of the speed reduction gear set is below the rated load, the intelligent encoder detects a rotational deviation angle between the first cylindrical spur gear and the second cylindrical spur gear, the servo motor adjusts the first cylindrical spur gear, so that the first cylindrical spur gear is aligned with the second cylindrical spur gear, the first electromagnet and the second electromagnet on the clamping block are powered off, the first spring pulls the iron plate to reset, causing the separation ring to push the second cylindrical spur gear to be re-meshed with the first cylindrical spur gear, the third spring resets to enable the clamping block to be separated from the support groove, and the second spring drives the telescopic rod to reset.

Based on the above, beneficial effects of the present invention are as follows:
A meshing transmission relationship between the speed reduction gear set and the servo motor is disconnected, to prevent the impact of the device on internal gear meshing after overload, preventing excessive friction at a position of the internal gear meshing, and preventing loose meshing due to excessive friction by an internal gear, which could cause inaccurate joint movement of the robot. The second cylindrical spur gear is separated from the first cylindrical spur gear during overload, to prevent continued operation after overload;
After the output shaft of the speed reduction gear set is buffered and supported, compared to the conventional technology where operation is directly stopped upon overload detection, in the present invention, after the second cylindrical spur gear is no longer meshed from the first cylindrical spur gear, external cargo drives the robot joint to deflect in a reverse direction, and the output shaft of the speed reduction gear set is buffered and supported via the telescopic rod and the second spring, preventing continuous compression of the robot joint against an external obstacle, preventing gears in the device remaining in a tightly meshed state under overload, reducing the duration of gear overload compression, preventing gear wear caused by prolonged asymmetric stress, and not affecting the operation of other robot joint modules. This prevents the cargo being carried by the robot from falling. In addition, in the conventional technology, after direct shutdown, the robot remains stationary, and because the cargo remains on the robot, the weight of the cargo continues to impose a load on the gears inside the robot joint module, causing the gears to be continuously stressed. A meshing relationship between the first cylindrical spur gear and the second cylindrical spur gear is disconnected, gear wear can be reduced, and then the service life of the gear can be improved.

### BRIEF DESCRIPTION OF THE DRAWINGS

FIG. 1 is a schematic perspective diagram of an overall structure of the present invention;

FIG. 2 is a schematic sectional perspective diagram of an overall structure of the present invention;

FIG. 3 is a schematic perspective diagram of an end plate, a separation ring, and other components of the present invention;

FIG. 4 is a schematic enlarged diagram of a position A in FIG. 3 of the present invention;

FIG. 5 is a schematic perspective diagram of the separation ring, a first electromagnet, and other components of the present invention;

FIG. 6 is a schematic enlarged diagram of a position B in FIG. 5 of the present invention;

FIG. 7 is a schematic perspective diagram of the end plate, a pressure sensor, a bearing, and other components of the present invention;

FIG. 8 is a schematic perspective diagram of a servo motor, a speed reduction gear set, a fastened ring, and other components of the present invention;

FIG. 9 is a schematic perspective diagram of a first cylindrical spur gear, a second cylindrical spur gear, a support groove, and other components of the present invention;

FIG. 10 is a schematic perspective diagram of the fastened ring, an inner ring frame, a telescopic rod, and other components of the present invention;

FIG. 11 is a schematic perspective diagram of a support housing, a clamping block, and other components of the present invention; and

FIG. 12 is a schematic perspective diagram of a position C in FIG. 11 of the present invention.

### DESCRIPTION OF THE EMBODIMENTS

The following describes technical solutions of embodiments of the present invention clearly and completely with reference to accompanying drawings of the embodiments. Obviously, the described embodiments are only some, not all, of the embodiments of the present invention. Based on the embodiments of the present invention, all other embodiments obtained by those skilled in the art without creative effort shall fall within the protection scope of the present invention.

The embodiments provided by the present invention will be described in detail as follows.

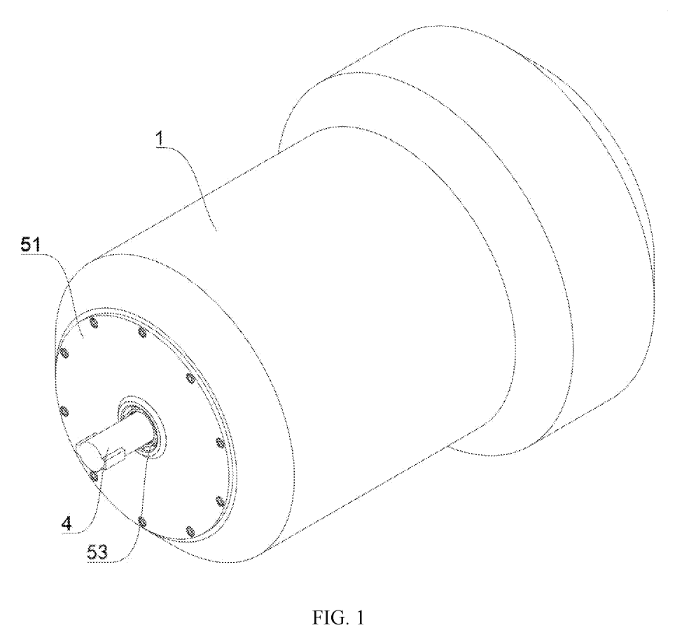

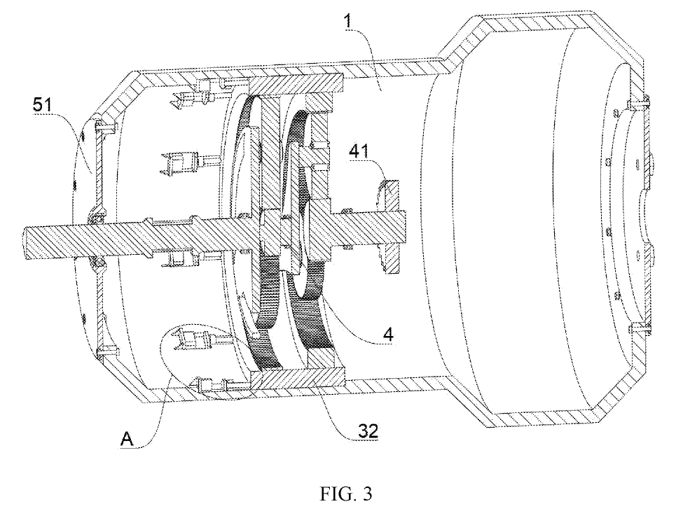

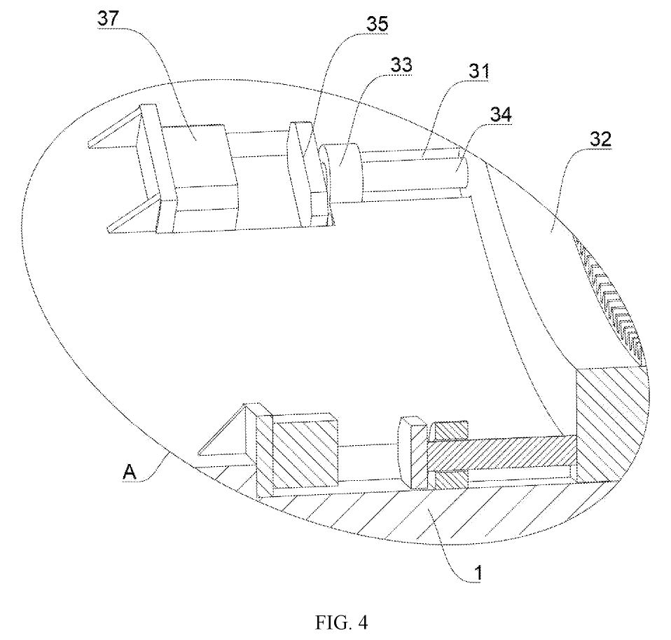

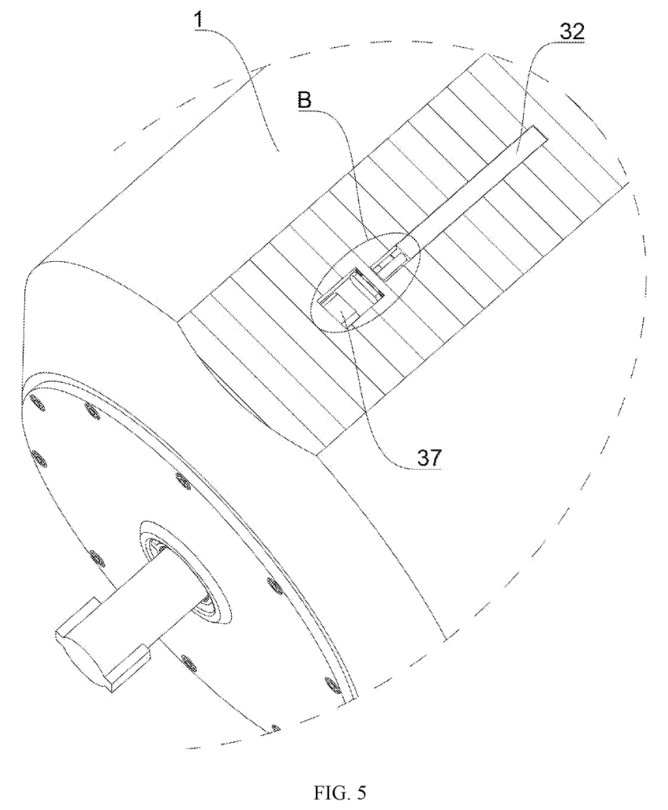

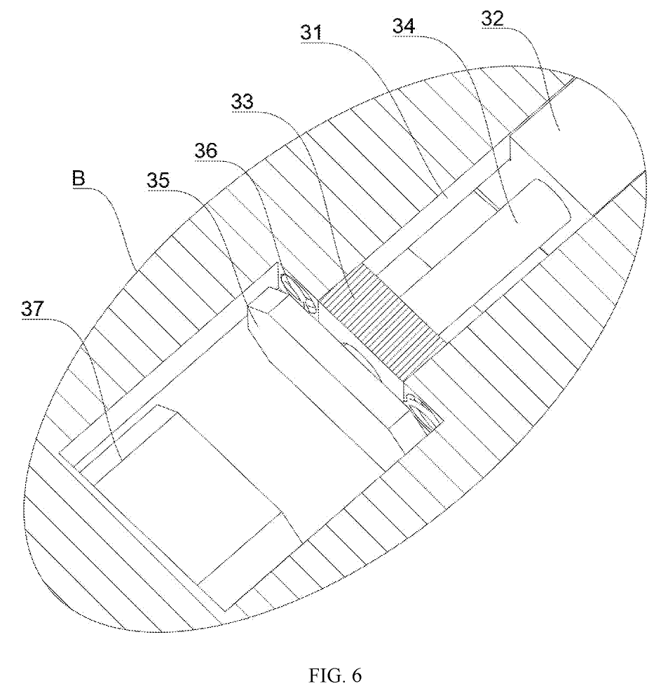

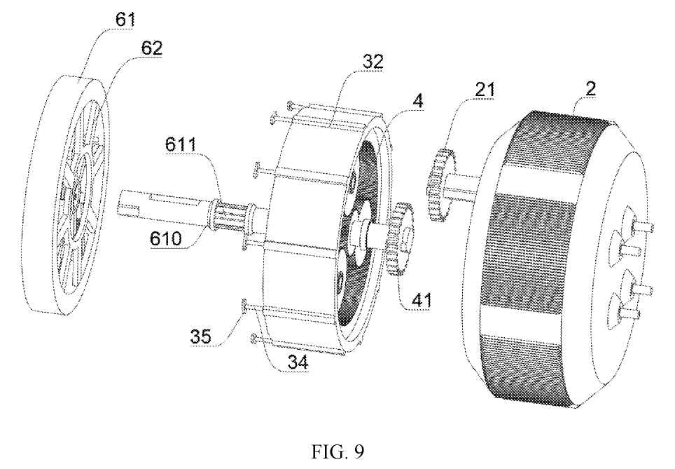

As shown in FIGS. 1-6, and 9, a robot joint module includes a module housing 1, with a servo motor 2 disposed inside the module housing 1. An intelligent encoder and a controller are disposed on the servo motor 2 for detecting an operating status of the servo motor 2 and controlling forward and reverse rotation of the servo motor 2. A separation assembly is disposed inside the module housing 1.

The intelligent encoder provides high-precision position feedback, can convert angular displacement into an electrical signal for dynamic error correction and dynamic compensation. Both the intelligent encoder and the servo motor 2 are electrically connected to the controller. The intelligent encoder can control the forward and reverse rotation of the servo motor 2 by using the controller, allowing real-time adjustment of a rotation angle of an output shaft of the servo motor 2. The intelligent encoder and the controller are known technologies and are not described herein.

The separation assembly includes multiple separation grooves 31 formed on an inner side surface of the module housing 1 and arranged in a circular array. A separation ring 32 slides inside the module housing 1, with multiple protrusions arranged in a circular array on an outer ring surface of the separation ring 32, a quantity of the protrusions matches a quantity of the separation grooves 31. The protrusions of the separation ring 32 are slidably connected inside an adjacent separation grooves 31. A stabilizing ring 33 is firmly connected to an interior of each separation groove 31. Multiple connecting rods 34 are annularly and equidistantly connected to a side surface of the separation ring 32, and a quantity of the connecting rods 34 is the same as a quantity of the separation grooves 31. The connecting rods 34 slide inside adjacent stabilizing rings 33. One end of each connecting rod 34 passing through the stabilizing ring 33 is firmly connected to an iron plate 35. A first spring 36 is connected between a surface of the iron plate 35 near the connecting rod 34 and a groove wall of the separation groove 31. A first electromagnet 37 is firmly connected to a groove wall of a side of the separation groove 31 away from the servo motor 2, and the first electromagnet 37 is electrically connected to the controller.

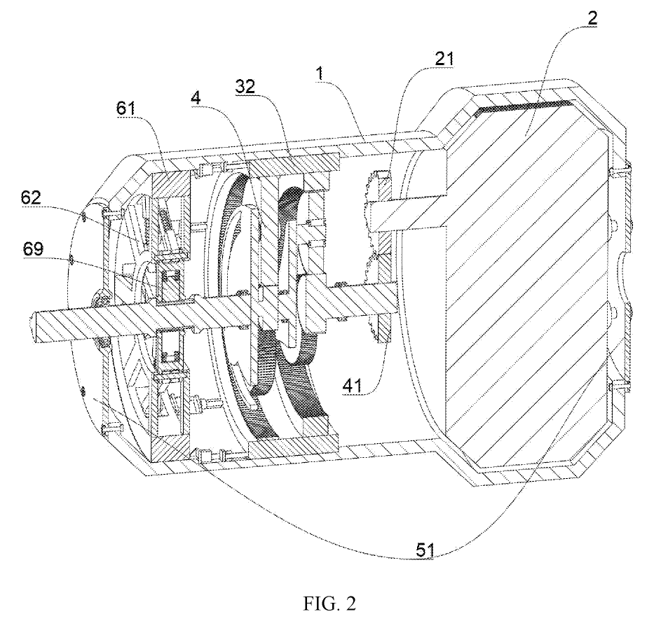

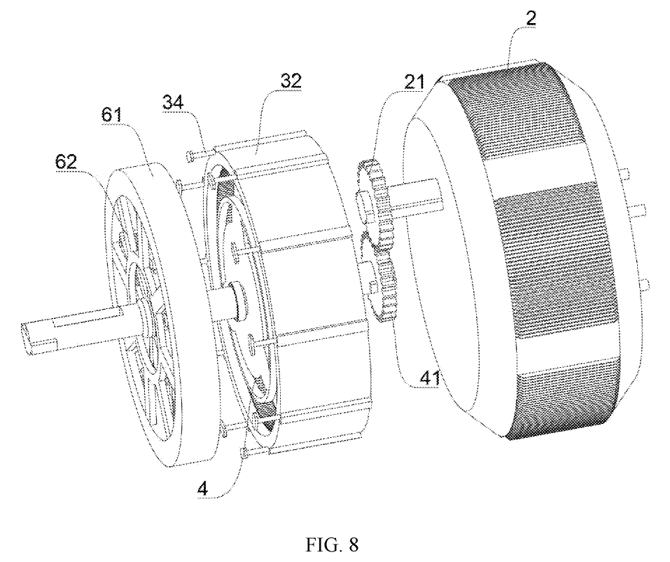

As shown in FIGS. 2, 8, and 9, a first cylindrical spur gear 21 is firmly connected to the output shaft of the servo motor 2. A speed reduction gear set 4 is disposed inside the separation ring 32, an output shaft and an input shaft are disposed on the speed reduction gear set 4, the input shaft is disposed on a side near the servo motor 2, and the output shaft is disposed on a side away from the servo motor 2. A second cylindrical spur gear 41 is firmly connected to the input shaft of the speed reduction gear set 4, and the first cylindrical spur gear 21 meshes with the second cylindrical spur gear 41.

The output shaft of the speed reduction gear set 4 is slidably connected to an external robot manipulator component through a key, so that when the speed reduction gear set 4 is moved by the separation ring 32, the output shaft of the speed reduction gear set 4 can still maintain a transmission connection with the external robot manipulator.

It should be noted that an intelligent encoder is also disposed on the separation ring 32 for detecting a rotational angle of the output shaft of the speed reduction gear set 4. The intelligent encoder is also electrically connected to the controller and can control rotation of the servo motor 2. When the first cylindrical spur gear 21 and the second cylindrical spur gear 41 are re-meshed after separation, the intelligent encoder and the controller can control the output shaft of the servo motor 2, so that the output shaft of the servo motor 2 drives the first cylindrical spur gear 21 to rotate to a position where the output shaft can mesh with the second cylindrical spur gear 41, thereby enabling the first cylindrical spur gear 21 and the second cylindrical spur gear 41 to re-mesh effectively.

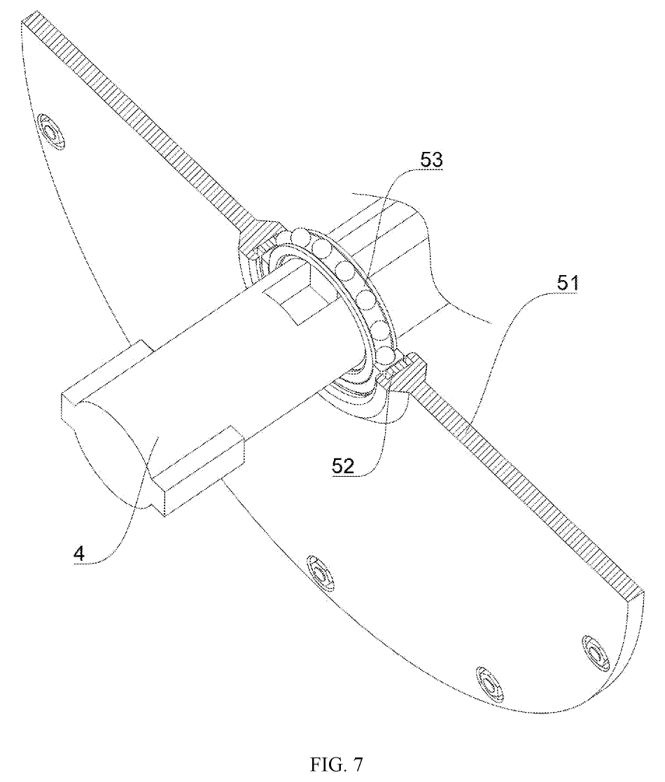

As shown in FIGS. 1, 2, and 7, a detection assembly is disposed on the module housing 1. The detection assembly includes two end plates 51 respectively fastened to both ends of the module housing 1 by bolts. The end plate 51 on a side away from the servo motor 2 is provided with a mounting hole for the output shaft of the speed reduction gear set 4 to pass through. The servo motor 2 is firmly connected to an adjacent end plate 51 by a bolt. A bearing 53 is mounted inside the mounting hole in the end plate 51, and an outer ring of the bearing 53 is firmly connected to the mounting hole in the end plate 51. Further, multiple pressure sensors 52 arranged in a circular array are firmly connected between the outer ring of the bearing 53 and an inner side wall of the mounting hole in the end plate 51. A slider is firmly connected to an inner side wall of an inner ring of the bearing 53. The inner ring of the bearing 53 can rotate within an outer ring via ball bearings. A sliding groove corresponding to the slider is formed on the output shaft of the speed reduction gear set 4, and the slider on the bearing 53 slides within the sliding groove. The pressure sensors 52 are electrically connected to the controller.

During rotation of the output shaft of the speed reduction gear set 4, the cooperation of the sliding groove and the slider can drive the inner ring of the bearing 53 to rotate. In addition, when the speed reduction gear set 4 moves, the output shaft of the speed reduction gear set 4 does not drive the bearing 53 to move, and only the slider slides within the sliding groove.

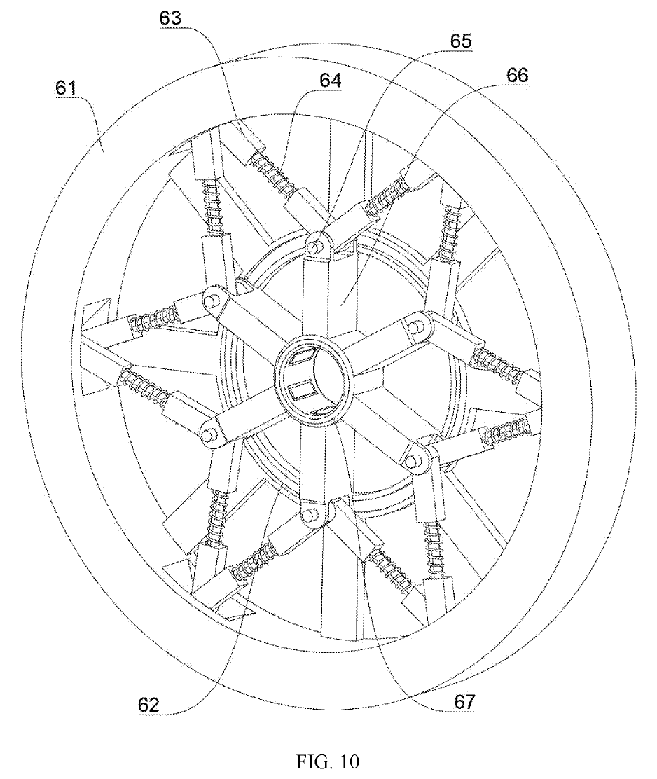

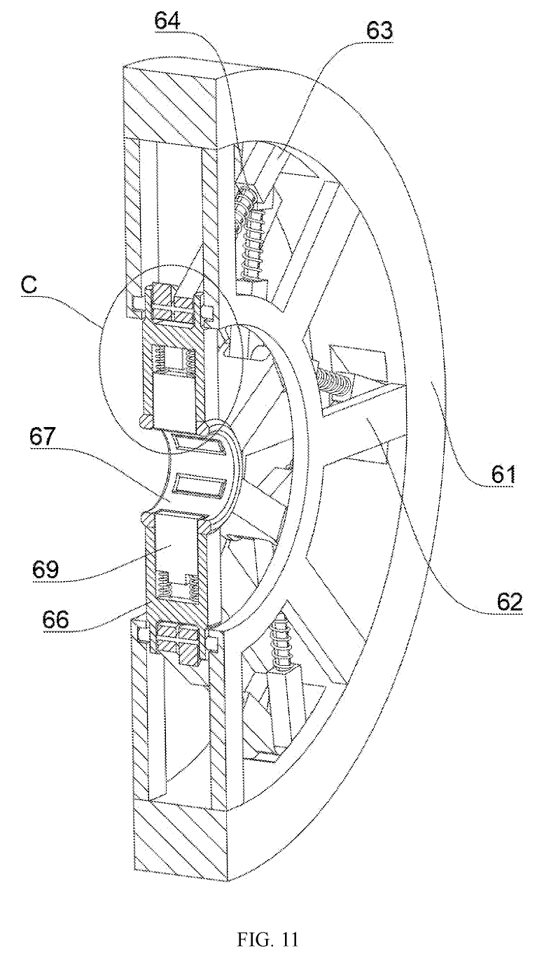

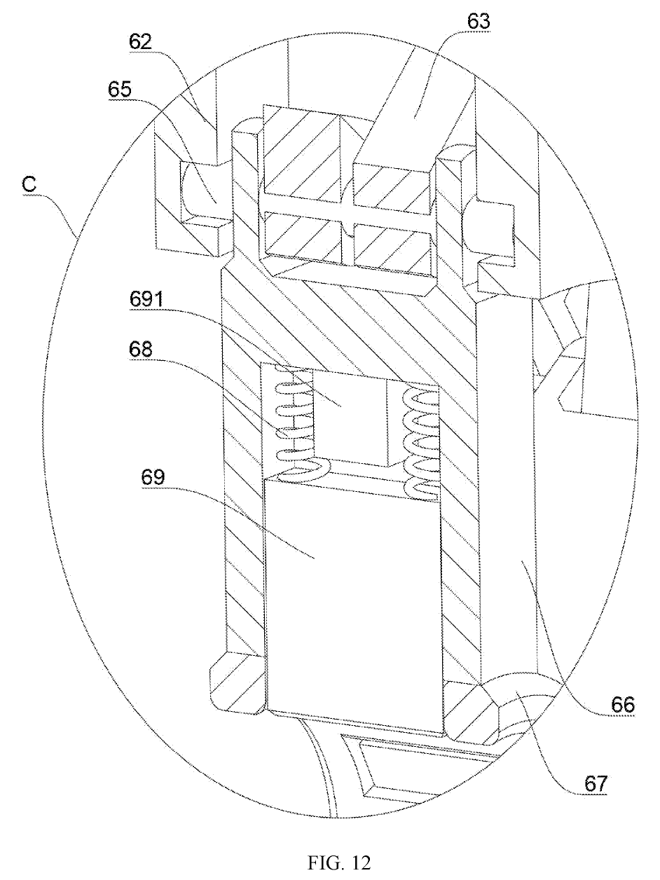

As shown in FIGS. 2, and 8-12, a support assembly for buffering the output shaft of the speed reduction gear set 4 is disposed inside the module housing 1. The support assembly includes a fastened ring 61 firmly connected to an inner side wall of the module housing 1. Two opposing inner ring frames 62 are firmly connected to an inner side wall of the fastened ring 61, and each of the two inner ring frames 62 includes a circular groove ring and multiple straight rods. Multiple sets of telescopic rods 63 are rotatably connected to an inner side wall of the fastened ring 61, each set including two telescopic rods 63. Each telescopic rod 63 includes a fastened end and a telescopic end, with a second spring 64 disposed between the fastened end and the telescopic end. Telescopic ends of two telescopic rods 63 in the same set are jointly and rotatably connected to a connecting shaft 65. Both ends of the connecting shaft 65 slide within circular groove rings of the two inner ring frames 62 respectively. Each connecting shaft 65 is firmly connected to a support housing 66. Multiple support housings 66 are jointly and firmly connected to an inner ring 67. Multiple openings are formed in the inner ring 67, with a quantity of the openings corresponding to a quantity of the support housings 66. The openings of the inner ring 67 are in communication with an interior of the adjacent support housing 66. The inner ring 67 is sleeved on an outer side of an output shaft of the speed reduction gear set 4. Two third springs 68 are symmetrically fastened inside each support housing 66. Ends of the two third springs 68 away from a connection to the support housing 66 are jointly and firmly connected to a clamping block 69. A second electromagnet is disposed inside the clamping block 69. A magnet 691 is firmly connected inside the support housing 66. After the second electromagnet on the clamping block is energized, magnetic poles on sides of the second electromagnet 69 and the magnet 691 that are close to each other are the same. Two limit rings 610, corresponding to a position of the inner ring 67, are firmly connected to the output shaft of the speed reduction gear set 4. Multiple support grooves 611 arranged in a circular array are formed on an outer surface of the output shaft of the speed reduction gear set 4 and located between the two limit rings 610. The support grooves 611 are elongated, and a quantity of the support grooves 611 corresponds to a quantity of the clamping blocks 69. Positions of the multiple support grooves 611 correspond to positions of the multiple clamping blocks 69. A length of the support groove 611 is greater than a width of the inner ring 67, so that when the clamping block 69 is inserted into the support groove 611 and the speed reduction gear set 4 is translating, the clamping block 69 can slide within the support groove 611 without affecting the translation of the speed reduction gear set 4. The second electromagnet on the clamping block 69 is electrically connected to the controller.

Based on the above preferred embodiments, the following describes a complete working process and principle of the above embodiments:

### Initial state

The first electromagnet 37 is not energized, thus the first electromagnet 37 does not attract the iron plate 35. In this case, the first spring 36 is not stretched by the iron plate 35, the second cylindrical spur gear 41 on the speed reduction gear set 4 remains meshed with the first cylindrical spur gear 21, the second spring 64 is not deformed, the second electromagnet on the clamping block 69 is not energized, and then the second electromagnet on the clamping block 69 does not repel the magnet 691, and the third spring 68 is not stretched by the clamping block 69. Under the action of the third spring 68, a surface of the clamping block 69 away from the third spring 68 is located within an opening of the inner ring 67 and does not contact the output shaft of the speed reduction gear set 4.

### Working state

When the robot needs to rotate a joint, the controller can control the servo motor 2 to rotate. The output shaft of the servo motor 2 drives the first cylindrical spur gear 21 to rotate, and the first cylindrical spur gear 21 synchronously drives the second cylindrical spur gear 41 to rotate. Through a speed reduction effect of the speed reduction gear set 4, high-speed and low-torque rotation transmitted by the servo motor 2 is converted into low-speed and high-torque rotation, so that the output shaft of the speed reduction gear set 4 drives a joint to be rotated by the robot to rotate as required.

### Separating the first cylindrical spur gear 21 from the second cylindrical spur gear 41

During rotation of the output shaft of the speed reduction gear set 4, if overload occurs, for example, when the robot encounters an obstacle while lifting cargo, it will cause overload at gears inside the speed reduction gear set 4 and at a meshing position between the second cylindrical spur gear 41 and the first cylindrical spur gear 21. Because the output shaft of the speed reduction gear set 4 is fitted to the pressure sensor 52 through the bearing 53, when the output shaft of the speed reduction gear set 4 is overloaded during rotation, a pressure exerted on the pressure sensor 52 increases. When a detected value of the pressure sensor 52 exceeds a preset threshold, the pressure sensor 52 controls the first electromagnet 37 to be energized by using the controller. The first electromagnet 37 attracts an adjacent iron plate 35 after energized, causing the iron plate 35 to move toward a side near the first electromagnet 37. During movement, the iron plate 35 stretches the first spring 36, and the iron plate 35 also drives the connecting rod 34 to move toward a side near the first electromagnet 37 inside the stabilizing ring 33. The connecting rod 34 drives the separation ring 32 to move. Under the guidance of the separation groove 31, the separation ring 32 moves inside the module housing 1 toward a side away from the servo motor 2, and the separation ring 32 drives the speed reduction gear set 4 inside the separation ring to entirely move toward a side away from the servo motor 2. The second cylindrical spur gear 41 on the input shaft of the speed reduction gear set 4 is no longer meshed with the first cylindrical spur gear 21, thereby preventing the impact of overload on internal gear meshing, preventing excessive friction at a position of the internal gear meshing, and preventing loose meshing due to excessive friction by an internal gear, which could cause inaccurate joint movement of the robot. The second cylindrical spur gear 41 is separated from the first cylindrical spur gear 21 during overload, to prevent continued operation after overload.

It should be noted that when the robot is gripping cargo, a gripping device used by the robot is a conventional adaptive gripping device. When the second cylindrical spur gear 41 is not meshed with the first cylindrical spur gear 21, a gripping force of the device on external cargo is not affected. To be specific, the cargo does not fall.

### Buffering support for the output shaft of the speed reduction gear set 4

When the first electromagnet 37 is energized, the second electromagnet on the clamping block 69 is also controlled to be energized. After the second electromagnet is energized, magnetic poles on sides of the second electromagnet and the magnet 691 that are close to each other are the same, so the second electromagnet on the clamping block 69 and the magnet 691 repel each other. In this case, the clamping block 69 moves toward a side away from the magnet 691, and the movement of the clamping block 69 stretches the third spring 68. In this case, the clamping block 69 passes through the opening in the inner ring 67 and is inserted into the adjacent support groove 611. Through an insertion relationship between the clamping block 69 and the support groove 611, the output shaft of the speed reduction gear set 4 and the support housing 66 remain relatively stationary. To be specific, when the output shaft of the speed reduction gear set 4 rotates, the clamping block 69 drives the support housing 66 to rotate synchronously. In addition, because the second cylindrical spur gear 41 is no longer meshed with the first cylindrical spur gear 21, when overload occurs during cargo lifting, the output shaft of the speed reduction gear set 4 tends to rotate in a reverse direction under the influence of external cargo's gravity. When the output shaft of the speed reduction gear set 4 rotates in reverse, the output shaft of the speed reduction gear set 4 causes, through the support groove 611, the clamping block 69 to drive the support housing 66 to rotate, and the support housing 66 drives the connecting shaft 65 to slide within the circular groove ring of the inner ring frame 62. The telescopic rod 63 can buffer the support housing 66, and the second spring 64 adaptively deforms, so that the support housing 66 cannot rotate smoothly, thereby buffering and supporting the output shaft of the speed reduction gear set 4. Through the buffering and locking of the telescopic rod 63 and the second spring 64, a rotation speed is gradually reduced, thus preventing reverse rotation of the output shaft of the speed reduction gear set 4. Compared to the conventional technology where operation is directly stopped upon overload detection, in the present invention, after the second cylindrical spur gear 41 is no longer meshed with the first cylindrical spur gear 21, external cargo drives the robot joint to deflect in a reverse direction, and the output shaft of the speed reduction gear set 4 is buffered and supported via the telescopic rod 63 and the second spring 64, preventing continuous compression of the robot joint against an external obstacle, preventing gears in the device remaining in a tightly meshed state under overload, reducing the duration of gear overload compression, preventing gear wear caused by prolonged asymmetric stress, without affecting the operation of other robot joint modules. This prevents the cargo being carried by the robot from falling. In addition, in the conventional technology, after direct shutdown, the robot remains stationary, and because the cargo remains on the robot, the weight of the cargo continues to impose a load on the gears inside the robot joint module, causing the gears to be continuously stressed. A meshing relationship between the first cylindrical spur gear 21 and the second cylindrical spur gear 41 is disconnected, so that gear wear can be reduced.

It should be noted that when the clamping block 69 moves toward the center of the inner ring 67, if the clamping block 69 is not aligned with the support groove 611, the clamping block 69 first contacts an outer surface of the output shaft of the speed reduction gear set 4 during movement. However, in this case, the output shaft of the speed reduction gear set 4 is in a rotatable state. Due to the gravity of the cargo, the output shaft of the speed reduction gear set 4 rotates in reverse, so that the output shaft of the speed reduction gear set 4 causes the support groove 611 to rotate with the shaft to a position aligned with the clamping block 69. Under the action of the magnet 691, the clamping block 69 is still inserted into the support groove 611, thereby achieving a limiting effect on the output shaft.

After the output shaft of the speed reduction gear set 4 is locked, the intelligent encoder monitors a rotational deviation angle between the first cylindrical spur gear 21 and the second cylindrical spur gear 41. Then, the output shaft of the servo motor 2 is controlled in low-speed mode to drive the first cylindrical spur gear 21 to compensate for the deviation, so as to adjust an angle with a deviation. Upon subsequent reconnection, precise operation and control can also be ensured, providing effective meshing conditions for re-meshing between the second cylindrical spur gear 41 and the first cylindrical spur gear 21, and preventing gear tooth collision during meshing between the second cylindrical spur gear 41 and the first cylindrical spur gear 21.

### Reset

After the transported cargo is removed or an obstacle is cleared, a compressive force received by the pressure sensor 52 decreases. When the compressive force drops back below a preset threshold, the pressure sensor 52 controls the first electromagnet 37 and the second electromagnet on the clamping block 69 to be powered off by using the controller. After powered off, the first electromagnet 37 no longer attracts the iron plate 35. Under the elastic reset action of the first spring 36, the iron plate 35 moves inside the separation groove 31 toward a side away from the first electromagnet 37. The iron plate 35 drives the connecting rod 34 inside the stabilizing ring 33 to move synchronously toward the side away from the first electromagnet 37. The connecting rod 34 causes the separation ring 32 to move along the separation groove 31 inside the module housing 1 toward a side near the servo motor 2. The separation ring 32 drives the speed reduction gear set 4 to move toward the side near the servo motor 2. The speed reduction gear set 4 drives the second cylindrical spur gear 41 on the input shaft thereof to approach the first cylindrical spur gear 21. In this case, the second cylindrical spur gear 41 is re-meshed with the first cylindrical spur gear 21.

It should be noted that when the speed reduction gear set 4 moves as a whole, the output shaft of the speed reduction gear set 4 moves synchronously. In this case, the clamping block 69 moves within the support groove 611. With the design allowing the clamping block 69 and the support groove 611 to be movable, when the clamping block 69 is inserted into the support groove 611, translational reset movement of the speed reduction gear set 4 is not affected.

In addition, after the second electromagnet on the clamping block 69 is powered off, magnetism is no longer generated, and thus the magnet 691 is no longer repelled by the second electromagnet on the clamping block 69. Under an elastic reset action of the third spring 68, the clamping block 69 retracts into the interior of the support housing 66, and the clamping block 69 is no longer inserted into the support groove 611. Under an elastic reset action of the second spring 64, the telescopic rod 63 returns to an initial state, thereby completing a re-connection between the servo motor 2 and the speed reduction gear set 4, allowing the servo motor 2 to drive the speed reduction gear set 4 for speed reduction through the cooperation of the first cylindrical spur gear 21 with the second cylindrical spur gear 41.

This embodiment further provides a method for using a robot joint module, which is used in the robot joint module as described above. The method includes the following steps:
Step 1: When the pressure sensor 52 detects that a load on the output shaft of the speed reduction gear set 4 exceeds a rated load, the first electromagnet 37 is energized and attracts the iron plate 35, and the iron plate 35 drives the connecting rod 34 and the separation ring 32 to move along the separation groove 31, causing the second cylindrical spur gear 41 to be separated from the first cylindrical spur gear 21;
Step 2: When the first electromagnet 37 is energized, the second electromagnet on the clamping block 69 is energized and repels the magnet 691, pushing the clamping block 69 into the support groove 611 to connect the output shaft of the speed reduction gear set 4 to the support housing 66, and the output shaft of the speed reduction gear set 4 is buffered and supported through the telescopic rod 63 and the second spring 64; and
Step 3: When the pressure sensor 52 detects that the load on the output shaft of the speed reduction gear set 4 is below the rated load, the intelligent encoder detects a rotational deviation angle between the first cylindrical spur gear 21 and the second cylindrical spur gear 41, the servo motor 2 adjusts the first cylindrical spur gear 21, so that the first cylindrical spur gear 21 is aligned with the second cylindrical spur gear 41, the first electromagnet 37 and the second electromagnet on the clamping block 69 are powered off, the first spring 36 pulls the iron plate 35 to reset, causing the separation ring 32 to push the second cylindrical spur gear 41 to be re-meshed with the first cylindrical spur gear 21, the third spring 68 resets to enable the clamping block 69 to be separated from the support groove 611, and the second spring 64 drives the telescopic rod 63 to reset.

The above descriptions are merely preferred embodiments of the present invention and are not intended to limit the present invention. Any modifications, equivalent replacements, improvements, and the like made within the spirit and principles of the present invention shall be included within the scope of protection of the present invention.

What is claimed is:

1. A robot joint module, comprising a module housing, wherein a servo motor is disposed inside the module housing, and a separation assembly is disposed inside the module housing,
the separation assembly comprises a separation groove formed on an inner side surface of the module housing, a separation ring is slidably disposed inside the module housing and is slidably connected to the separation groove, a stabilizing ring is firmly connected inside the separation groove, a connecting rod is firmly connected to a side surface of the separation ring, passes through the stabilizing ring, and is firmly connected to an iron plate, a first spring is firmly connected between a surface of the iron plate near the connecting rod and a groove wall of the separation groove, a first electromagnet is firmly connected to a groove wall of a side of the separation groove away from the servo motor, a first cylindrical spur gear is firmly connected to an output shaft of the servo motor, a speed reduction gear set is disposed inside the separation ring, an input shaft is disposed on a side of the speed reduction gear set near the servo motor, an output shaft is disposed on a side of the speed reduction gear set away from the servo motor, a second cylindrical spur gear is firmly connected to the input shaft of the speed reduction gear set, and the first cylindrical spur gear meshes with the second cylindrical spur gear; and further comprising a detection assembly for detecting a load borne by the output shaft of the speed reduction gear set and a support assembly for limiting the output shaft;
wherein an outer ring surface of the separation ring is provided with a protrusion, the protrusion of the separation ring is slidably connected inside the separation groove, and the connecting rod slides inside the stabilizing ring;
wherein the detection assembly comprises two end plates respectively fastened to both ends of the module housing by bolts, a mounting hole for the output shaft of the speed reduction gear set is provided in an end plate on a side away from the servo motor, the servo motor is firmly connected to an adjacent end plate by a bolt, a bearing is mounted in the mounting hole in the end plate, an outer ring of the bearing is fastened to the mounting hole in the end plate, multiple pressure sensors arranged in an annular array are fastened between the outer ring of the bearing and an inner side wall of the mounting hole in the end plate, a slider is fastened to an inner side wall of an inner ring of the bearing, a sliding groove corresponding to the slider is formed on the output shaft of the speed reduction gear set, and the slider on the bearing slides within the sliding groove; and
wherein the support assembly comprises a fastened ring firmly connected to an inner side wall of the module housing, two inner ring frames disposed opposite to each other are firmly connected to an inner side wall of the fastened ring, circular groove rings are provided on the inner ring frames, multiple sets of telescopic rods are rotatably connected to the inner side wall of the fastened ring, each set comprises two telescopic rods, each telescopic rod comprises a fastened end and a telescopic end, a second spring is disposed between the fastened end and the telescopic end, the fastened end is rotatably connected to the fastened ring, telescopic ends of the two telescopic rods in the same set are jointly and rotatably connected to a connecting shaft, both ends of the connecting shaft are slidably connected to the circular groove rings of the two inner ring frames respectively, each connecting shaft is firmly connected to a support housing, multiple support housings are jointly and firmly connected to an inner ring, multiple openings are formed in the inner ring, with a quantity of the openings corresponding to a quantity of the support housings, the openings of the inner ring are in communication with an interior of the adjacent support housing, the inner ring is sleeved outside the output shaft of the speed reduction gear set, two third springs are symmetrically fastened inside each support housing, ends of the two third springs away from a connection to the support housing are jointly and firmly connected to a clamping block, a second electromagnet is disposed inside the clamping block, a magnet is firmly connected inside the support housing, and intelligent encoders are provided on the servo motor and the separation ring respectively.

2. The robot joint module according to claim 1, wherein after the second electromagnet on the clamping block is energized, magnetic poles on sides of the second electromagnet and the magnet that are close to each other are the same.

3. The robot joint module according to claim 2, wherein the support assembly further comprises two limit rings firmly connected to the output shaft of the speed reduction gear set, multiple support grooves are formed on an outer surface of the output shaft of the speed reduction gear set and located between the two limit rings, and a quantity of the support grooves corresponds to a quantity of the clamping blocks.

4. A method for using a robot joint module, used in the robot joint module according to claim 3, wherein the method comprises the following steps:
step 1: when the pressure sensor detects that a load on the output shaft of the speed reduction gear set exceeds a rated load, the first electromagnet is energized and attracts the iron plate, and the iron plate drives the connecting rod and the separation ring to move along the separation groove, causing the second cylindrical spur gear to be separated from the first cylindrical spur gear;
step 2: when the first electromagnet is energized, the second electromagnet on the clamping block is energized and repels the magnet, pushing the clamping block into the support groove to connect the output shaft of the speed reduction gear set to the support housing, and the output shaft of the speed reduction gear set is buffered and supported through the telescopic rod and the second spring; and
step 3: when the pressure sensor detects that the load on the output shaft of the speed reduction gear set is below the rated load, the intelligent encoder detects a rotational deviation angle between the first cylindrical spur gear and the second cylindrical spur gear, the servo motor adjusts the first cylindrical spur gear, so that the first cylindrical spur gear is aligned with the second cylindrical spur gear, the first electromagnet and the second electromagnet on the clamping block are powered off, the first spring pulls the iron plate to reset, causing the separation ring to push the second cylindrical spur gear to be re-meshed with the first cylindrical spur gear, the third spring resets to enable the clamping block to be separated from the support groove, and the second spring drives the telescopic rod to reset.
